(19) United States
(12) Patent Application Publication
(10) Pub. No.: US 2006/0210942 A1
(43) Pub. Date: Sep. 21, 2006

(54) Orthodontic fastening element

(75) Inventors: Mark S. Pace, Pforzheim (DE); Michael Reise, Bretten (DE); Friedrich Sernetz, Pforzheim (DE); Klaus Wigger, Neulingen (DE)

Correspondence Address: LEYDIG VOIT & MAYER, LTD, 700 THIRTEENTH ST. NW, SUITE 300, WASHINGTON, DC, 20005-3960, US

(73) Assignee: DENTAURUM J.P. WINKELSTROETER KG, Ispringen (DE)

(21) Appl. No.: 11/370,032

(22) Filed: Mar. 8, 2006

Related U.S. Application Data
(63) Continuation of application No. PCT/EP04/09880, filed on Sep. 4, 2004.

(30) Foreign Application Priority Data
Sep. 8, 2003 (DE) 103 41 985.3

(51) Int. Cl. A61C 3/00

(52) U.S. Cl. 433/8

(57) ABSTRACT

To provide an orthodontic fastening element, in particular a bracket, comprising a molding made of a non-metallic material, the fastening element having increased acceptance, particularly among younger patients, by virtue of the fact that it has at least in a partial region a lasting colored tint that is distinctly different from the color of the teeth, it is proposed according to the invention that the fastening element comprises an ion-doped ceramic material.

This application is a continuation of international application number PCT/EP2004/009880 filed on Sep. 4, 2004, that claims the benefit of German application number 103 41 985.3 of Sep. 8, 2003, both of which are incorporated herein by reference in their entirety and for all purposes.

### BACKGROUND OF THE INVENTION

The invention relates to an orthodontic fastening element, in particular a bracket, comprising a molding made of a non-metallic material, the fastening element having at least in a partial region a colored tint that is distinctly different from the color of the teeth.

Orthodontic fastening elements are used for example in the form of brackets and buccal tubes, which in orthodontic treatment are fixed to people's teeth to correct their positioning. Stainless steel may be used for producing fastening elements of this type. However, this has a metallic gleam and is therefore obtrusive in a cosmetically adverse way.

Efforts have therefore been made to give the fastening elements an appearance that approximates to the color of the teeth. For instance, in EP 0 337 307 B1 it is proposed to produce brackets and buccal tubes from aluminum oxide moldings, it being intended for the molding to have the best possible transparency in the range of visible light and in the range of near ultraviolet light and near infrared light, so that the fastening element presents the color of the tooth lying underneath it and therefore differs little or not at all from the color of the teeth. The fastening element itself is therefore intended to be as imperceptible as possible.

WO 89/08085 describes a polycrystalline, translucent ceramic bracket which itself is colorless and, on account of its transparency, takes on the color of the tooth lying under it. This bracket is also intended to differ in its coloring as little as possible from the tooth.

A further ceramic bracket is described in EP 0 297 908 B1. This bracket is also intended as far as possible to be highly transparent and, if anything, have a yellowish tint corresponding to the color of the teeth, to make it as indistinguishable as possible from the tooth lying under it.

In spite of the objective of providing patients with a bracket that is as unobtrusive as possible, brackets of this type are often only reluctantly accepted, particularly by younger patients.

In DE 196 03 189 A1 it is therefore proposed to produce orthodontic devices, in particular brackets, from a material which contains a luminous, i.e. phosphorescent or fluorescent, pigment. Depending on the pigment chosen, the device may shine in normal daylight or when irradiated with light in the dark. The luminous pigments, which are admixed with a base material preferably in a proportion by weight of 10% to 15%, allow different colors to be created in daylight and at night.

Transparent brackets are only slightly distinguishable from the tooth lying underneath. This makes it more difficult for the bracket to be aligned and fastened on the teeth, since the edges of the brackets are difficult to see. However, it is very important for the desired correction of the position of the teeth that the brackets are aligned as exactly as possible. In U.S. Pat. No. 5,716,208 A, it is therefore proposed to provide the otherwise transparent brackets with a color coating that is soluble in alcohol. On account of the color coating, the brackets can be easily seen when they are respectively being fastened to a tooth. After fastening, the color coating can be removed by means of an alcohol solution. If the patient wishes, the coating can also remain for some time, but it does fade after a few days.

U.S. Pat. No. 6,267,590 B1 discloses a bracket with a colored antimicrobial coating. The coating gives the bracket an antimicrobial effect and the coloring makes the bracket easy to see, so that its alignment and attachment on the tooth is made easier. The coloring is preferably created by pigments, which can be removed by dissolving once the bracket has been secured. The coating is preferably applied to a bracket body by means of a powder coating process. Alternatively, it may be envisaged to mix the material having an antimicrobial effect with the material of the bracket body and subsequently process the mixture in the usual manner, for example by injection molding.

It is an object of the present invention to provide an orthodontic fastening element of the type mentioned at the beginning which has increased acceptance, particularly among younger patients, by virtue of the fact that, at least in a partial region, it presents a lasting colored tint that is distinctly different from the color of the teeth.

### SUMMARY OF THE INVENTION

This object is achieved according to the invention in the case of an orthodontic fastening element of the generic type by the fastening element comprising an ion-doped ceramic material coloring the fastening element.

The invention includes the idea that, particularly among young people, the acceptance of orthodontic treatment, and an associated orthodontic fastening element which is fixed to the tooth and generally is indeed visible ultimately, can in many cases be increased by special color accents of the fastening element. The fastening element is therefore very distinctly distinguishable in its coloration from the tooth, at least in a partial region. For example, the fastening element may be of a bright color, at least in a certain region, in particular an intensive red, yellow, green or blue. In the region having the coloration, the color of the tooth can scarcely show through the fastening element; at least the color of the tooth is greatly distorted by the colored partial region. To achieve the coloration, the fastening element comprises ion-doped ceramic material. The ion-doped ceramic material can be used to achieve a very lasting coloration.

Choice of an appropriate doping material allows different colorations to be achieved, in particular colorations which are very distinctly different from the color of the teeth and have a lasting effect. The colorations are distinguished in particular by the fact that they are not changed, or only slightly changed, by mechanical or chemical attack, such as for example that occurring when the teeth are cleaned.

It is of advantage if the ceramic material is an ion-doped oxidic ceramic material. Doped aluminum oxide, zirconium oxide and/or dental ceramic materials are used with preference. By means of ceramic materials of this type, virtually all colors of the color spectrum can be achieved, it being possible for the colors to be very pure, clear and bright.

Polyvalent ions are preferably used for the doping of the ceramic material, in particular polyvalent transition metal ions and/or polyvalent rare earth ions.

It may be provided that the ceramic material has a number of dopings. It is advantageous in this respect if the individual doping materials are respectively in a proportion by mass of up to 0.5%, the proportion by mass of the entire doping material altogether being about 1% at most. A low proportion by mass of the doping material is advantageous, since the properties of the ceramic material as such, for example its hardness and strength, are then not adversely influenced by the doping, but rather the properties of the ceramic material remain virtually unchanged.

The relatively low proportion by mass of the entire doping material allows the fastening element according to the invention to be given an estheticly appealing, colored translucent/transparent appearance. Alternatively, it may also be provided that the fastening element is made an opaque color.

To achieve a coloration that is distinctly different from the color of the teeth, it is preferred to use doping materials with in each case a proportion by mass of about 0.1% at most, the proportion by mass of all the doping material not exceeding 0.5%.

It may be provided that the molding of the fastening element consists of ion-doped ceramic material, which is distinguished by a coloration that differs from the color of the teeth and has a very lasting effect.

Alternatively or additionally, it may be provided that the molding has a coating with ion-doped ceramic material.

In the case of an advantageous embodiment, it is provided that a coating of ion-doped ceramic material is applied to the molding.

It is advantageous if, at least in an uncoated region, the molding is made transparent or translucent, since this makes the uncoated region of the molding recede very much in its coloration in relation to the coated region, and the fastening element fixed to the tooth approximates to the color of the teeth in the uncoated region of the molding, while in the coated region of the molding it is distinguishable very distinctly from the color of the teeth.

As coating material for the molding, ion-doped oxidic ceramic material is preferably baked on. Doped aluminum oxide, zirconium oxide and/or dental ceramic materials may be used in particular for this, as already explained in detail above with reference to moldings of ion-doped ceramic materials. The doping is preferably performed by means of polyvalent ions, in particular by means of polyvalent transition metal ions or polyvalent rare earth ions. The individual doping materials may once again be respectively in a proportion by mass of up to 0.5%, the proportion by mass of all the doping materials altogether being about 1% at most.

The following description of preferred embodiments of the invention serves for a more detailed explanation in conjunction with the drawings.

### BRIEF DESCRIPTION OF THE DRAWINGS

FIG. 1 shows a pictorial representation of a first embodiment of an orthodontic fastening device according to the invention;

FIG. 2 shows a sectional representation of the fastening device according to FIG. 1; and

FIG. 3 shows a sectional representation of a second embodiment of an orthodontic fastening device according to the invention.

### DETAILED DESCRIPTION OF THE INVENTION

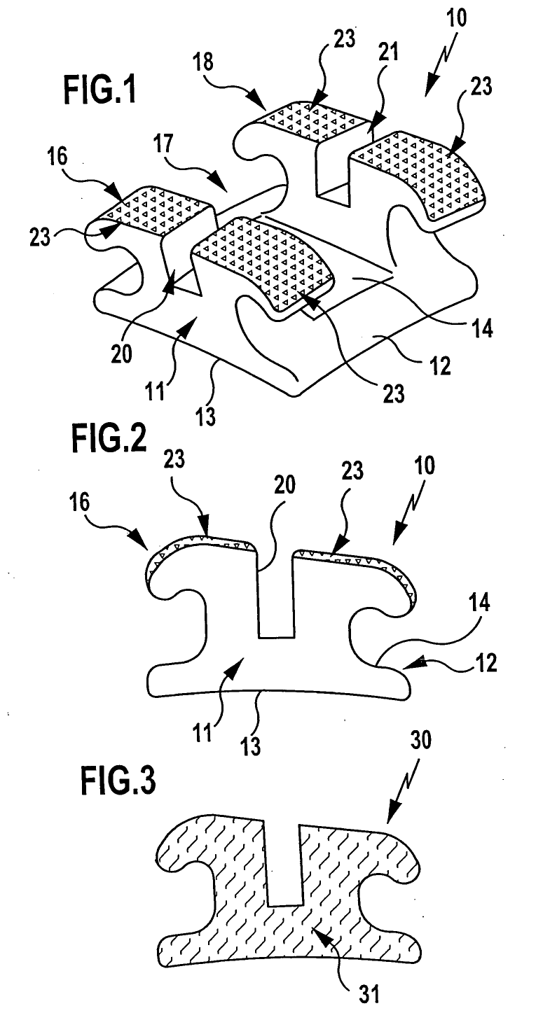

In FIGS. 1 and 2, a first embodiment of an orthodontic fastening device according to the invention is represented in the form of a bracket designated overall by the reference numeral 10. This comprises a molding 11 with a base 12, which can be fastened by its rear side 13 to a tooth and in the region of its front side 14 goes over integrally into a first pair of retaining wings 16, and a second pair of retaining wings 18, separated from the first pair by means of a transverse groove 17. The two pairs of retaining wings 16 and 18 have in each case a longitudinal groove 20 and 21, respectively, for receiving a wire, the spring forces of which are transferred to the bracket, and consequently to the tooth, for the orthodontic treatment.

The molding 11 is produced from aluminum oxide powder, which has been pressed and sintered in the customary manner. Pressing and sintering processes of this type are known to the person skilled in the art, for example from EP 0 297 908 B1. The molding 11 is highly transparent to visible light and also to light from the near ultraviolet and infrared ranges, so that the color of the teeth can show through.

On the front side, which is facing the patient's lips when the bracket 10 is in use, the two pairs of retaining wings 16 and 18 have in each case a coating 23 of ion-doped ceramic material baked onto the molding 11. The coating gives the bracket 10 in these regions a lasting colored tint that is distinctly different from the color of the patient's teeth. It may be provided, for example, that the coating 23 is blue, yellow, green or red.

The coating 23 of ion-doped ceramic material gives the bracket 10 in the region of its front side a bright coloration, by which the acceptance of brackets of this type can be increased, specifically in the case of younger patients. An aluminum oxide, zirconium oxide or dental ceramic material may be used for example as the ceramic material. The doping is performed by means of polyvalent ions, it being possible, depending on the doping material that is used, for a multiplicity of different lasting colorations to be achieved, by which the acceptance of the bracket 30 is increased, particularly among younger patients.

In FIG. 3, an alternative configuration of an orthodontic fastening element is represented in the form of a bracket designated overall by the reference numeral 30. With regard to its shaping, this bracket is formed identically to the bracket 10 explained above with reference to FIGS. 1 and 2. To avoid repetition, reference is made to the explanations given above in this respect. The bracket 30 is distinguished from the bracket 10 in that it is produced from a molding 31 which consists of ion-doped ceramic material and therefore has a lasting colored tint that is distinctly different from the color of the patient's teeth, without an additional layer of color or coating being required for this purpose. An aluminum oxide material or else a zirconium oxide or dental ceramic material that is colored by the doping may be used for the molding 31.

1. An orthodontic fastening element, providing a bracket for use with teeth, comprising a molding made of a non-metallic material, the fastening element having at least in a partial region a lasting colored tint that is distinctly different from the color of the teeth, and the fastening element comprising an ion-doped ceramic material coloring the fastening element.

2. The fastening element as claimed in claim 1, wherein the ceramic material is an ion-doped oxidic ceramic material.

3. The fastening element as claimed in claim 2, wherein the ceramic material is an ion-doped aluminum oxide, zirconium oxide and/or dental ceramic material.

4. The fastening element as claimed in claim 1, wherein the ceramic material is doped with polyvalent ions.

5. The fastening element as claimed in claim 4, wherein the ceramic material is doped with polyvalent transition metal ions and/or polyvalent rare earth ions.

6. The fastening element as claimed in claim 4, wherein the individual doping materials are respectively in a proportion by mass of up to 0.5%, the proportion by mass of the entire doping material altogether being about 1% at most.

7. The fastening element as claimed in claim 1, wherein the molding consists of ion-doped ceramic material.

8. The fastening element as claimed in claim 1, wherein the molding has a coating with ion-doped ceramic material.

9. The fastening element as claimed in claim 8, wherein a coating of ion-doped ceramic material is baked onto the molding.

10. The fastening element as claimed in claim 9, wherein the coating material is an ion-doped oxidic ceramic material.

11. The fastening element as claimed in claim 9, wherein the coating material is an ion-doped aluminum oxide, zirconium oxide and/or dental ceramic material.

12. The fastening element as claimed in claim 9, wherein the coating material is doped with polyvalent ions.

13. The fastening element as claimed in claim 9, wherein the coating material is doped with polyvalent transition metal ions and/or polyvalent rare earth ions.

14. The fastening element as claimed in claim 12, wherein the individual doping materials are respectively in a proportion by mass of up to 0.5%, the proportion by mass of the entire doping material altogether being about 1% at most.

15. The fastening element as claimed in claim 8, wherein, at least in an uncoated region, the molding is made transparent or translucent.
